(19) United States
(12) Patent Application Publication
(10) Pub. No.: US 2024/0095855 A1
(43) Pub. Date: Mar. 21, 2024

(54) LEGAL DOCUMENT TRANSFER WITH SIGN OFF FOR INCARCERATED INMATES

(71) Applicant: Jeremy Albert Radino, Blue Point, NY (US)

(72) Inventor: Jeremy Albert Radino, Blue Point, NY (US)

(21) Appl. No.: 18/515,860

(22) Filed: Nov. 21, 2023

(51) Int. Cl. G06Q 50/18; G06Q 50/26; G07F 17/26

(52) U.S. Cl. CPC G06Q 50/18; G06Q 50/265; G07F 17/266; G06Q 2220/10

(57) ABSTRACT

Methods and systems for secure digital transport and delivery of confidential and privileged legal documents to incarcerated recipients are disclosed. This method comprises generating an encrypted PDF document which is then stored on encrypted storage before being delivered and printed directly to the incarcerated recipient via secure computer system. Furthermore, the result of the delivery is recorded via photograph of the inmate along with the inmate's signature, and a receipt containing both is automatically generated and returned to the sender. Once that email is sent, the server completely purges the document from the system. A transaction log is kept for both users and correctional facilities.

### TECHNICAL FIELD

This invention relates to secure legal mail delivery systems, and in particular to providing an end-to-end encrypted solution for inmates to receive legal correspondence from their lawyers whilst also providing sign off upon receipt of documents.

### BACKGROUND ART

Some existing systems exist to deliver legal mail to incarcerated inmates, such as USPS delivery. From simple legal documents to full hearing transcripts the Legal Document Delivery System lets lawyers provide documents to their clients in a secure and tracked manner.

The Legal Document Delivery System also removes risks associated with traditional mail delivery systems as the documents print once authorized by the prison inmate, whilst a guard is present.

The document once delivered is acknowledged by the inmate, guaranteeing that the correct recipient has received the paperwork.

### SUMMARY

A mail delivery system can provide correspondence from one party to another, whilst also removing risk of physical mail-based systems such as the United States Postal Service. Documents sent via the system cannot be tampered with, getting from order to delivery on fresh paper managed by the prison facility.

The delivery system can also track the delivery times of documents, providing peace of mind to legal institutions that mail is getting to their clients in a timely manner.

Reporting via the Legal Document Delivery System back-office system also provides easy to understand delivery reports, and for administrators details of orders/payments.

The features and advantages described in this summary and the following detailed description are not all inclusive. Many additional features and advantages will be apparent to one of ordinary skills in the art in view of the drawings, specifications and claims.

### BRIEF DESCRIPTION OF THE DRAWINGS

FIG. 1 is a system diagram of the Legal document delivery system in its most basic form.

FIG. 2 is a block diagram illustrating the different modules inside the Legal document delivery system.

FIG. 3 is a block diagram illustrating the modules in use to register a lawyer 101 on the system 105.

FIG. 4 is a block diagram illustrating the authorization module 215 usage in order to authorize a lawyer 101.

FIG. 5 is a block diagram illustrating the document order process utilizing multiple modules from the standpoint of a lawyer 101.

FIG. 6 is a block diagram illustrating the synchronization of Legal Back Office 105 to Legal Program 107.

FIG. 7 is a block diagram illustrating the document print/delivery flow of the Legal Program 107.

FIG. 8 is a block diagram illustrating the synchronization of Legal Program 107 to the Legal Back Office 105.

### DETAILED DESCRIPTION

### System Overview 100

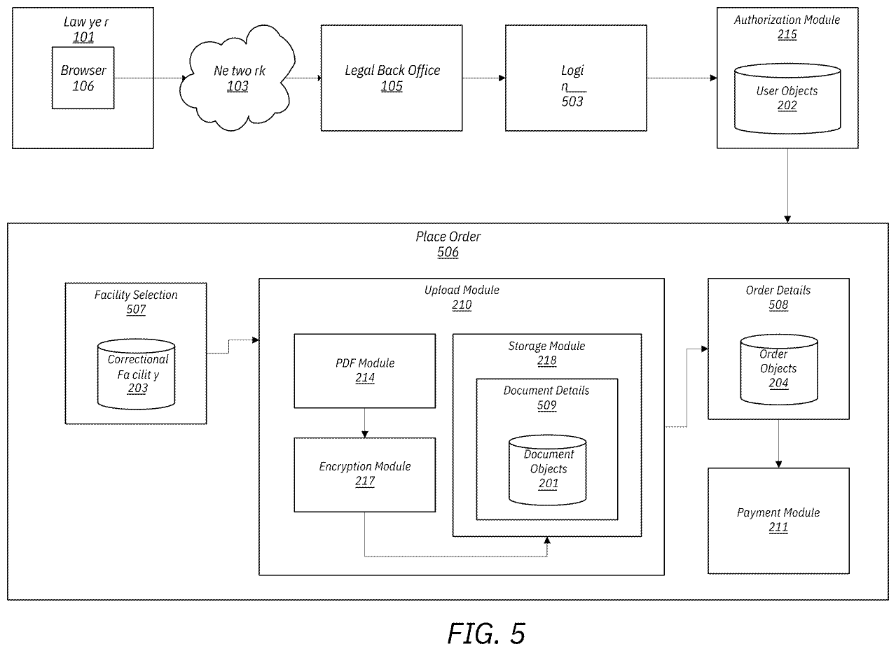

Referring now to FIG. 1, there is shown the system architecture of one embodiment of the present invention. FIG. 1 and the other figures use like reference numerals to identify like elements. A letter after a reference numeral, such as FIG. 5, “506A”, indicates a process unique to that reference numeral. A reference numeral in the text without a following letter, such as “101”, refers tO any or all of the elements in the figures bearing that reference numeral (e.g., “101” in the text refers to both “101” and “101A” in the figures).

The network 103 represents the communication pathways between the lawyer 101, the correctional facility 102 and the legal back office 105. In one embodiment, the network is the Internet. The network can also utilize dedicated or private communication links (e.g., WAN, MAN, or LAN) that are not necessarily part of the Internet. The network uses standard communications technologies and/or protocols.

The web server 104 presents web pages or other web content, which form the basic interface to the lawyer(s), and correctional facilities 101, 102. The lawyer(s) and correctional facilities use respective client devices 101, 102 to access one or more web pages, and provide data to and from the Legal Back Office 105. In the context of this application, “data” is understood to include information about a correctional facility, lawyer, information about an inmate, the legal document itself, and the like. For example, for information related to an order, the data can include information such as number of pages, price, inmate name, unique pin, correctional facility, date and the like.

A lawyer 101 is the sender of the system's input. Lawyers 101 specify a correctional facility 102, then specify an inmate to receive the documents along with a unique unlock pin for the order.

The correctional facility 102 is another type of user of the Legal Back Office 105 system, the facility utilizes a preconfigured application 107 to connect to the Legal Back Office 105 to synchronize orders for inmates, to then be printed and delivered in person.

In one embodiment, the client devices 106, 107 are used by the lawyer(s) 101, and correctional facilities 102 for interacting with the Legal Back Office 105. A client device can be any device that is or incorporates a computer such as a personal computer (PC), a desktop computer, a laptop computer, a notebook, a smartphone, or the like. A computer is a device having one or more general or special purpose processors, memory, storage and networking components (either wired, or wireless). The device executes an operating system, for example, a Microsoft Windows-compatible operating system (OS), Apple OSX or iOS, a Linux distribution, or Google's Android OS. In some embodiments, the client device 101, may use a web browser such as Microsoft Edge, Mozilla Firefox, Google Chrome, Apple Safari and/or Opera as an interface to interact with the Legal Back Office 105.

The Legal Back Office system 105 allows correctional facility devices 107 to communicate information to and from the system via SSL encrypted web calls.

### Back Office System 105

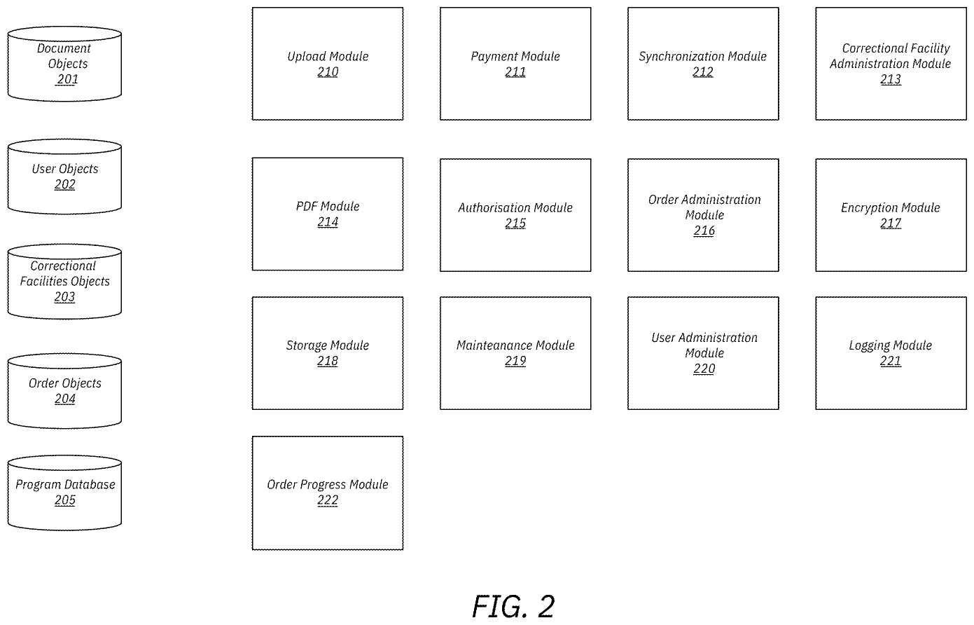

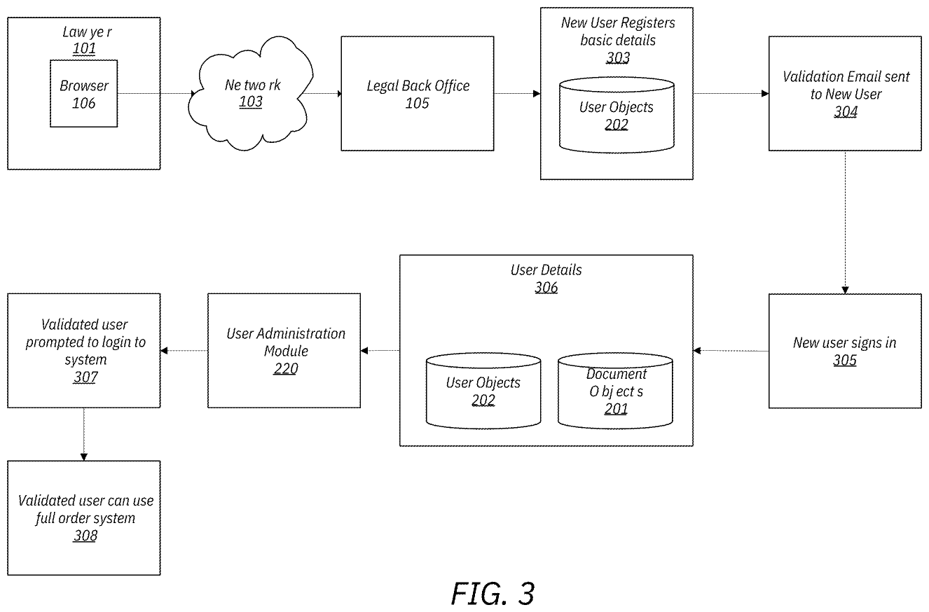

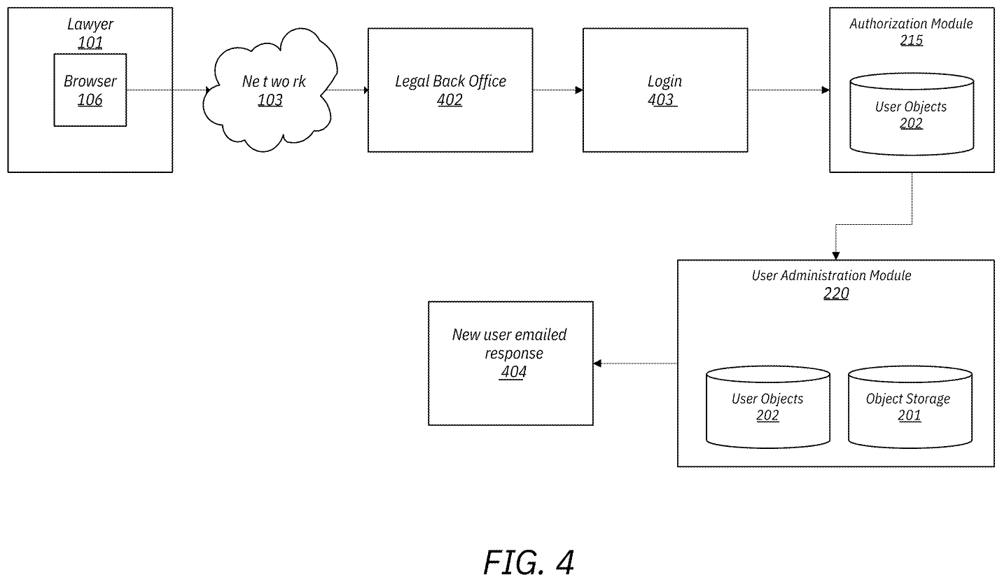

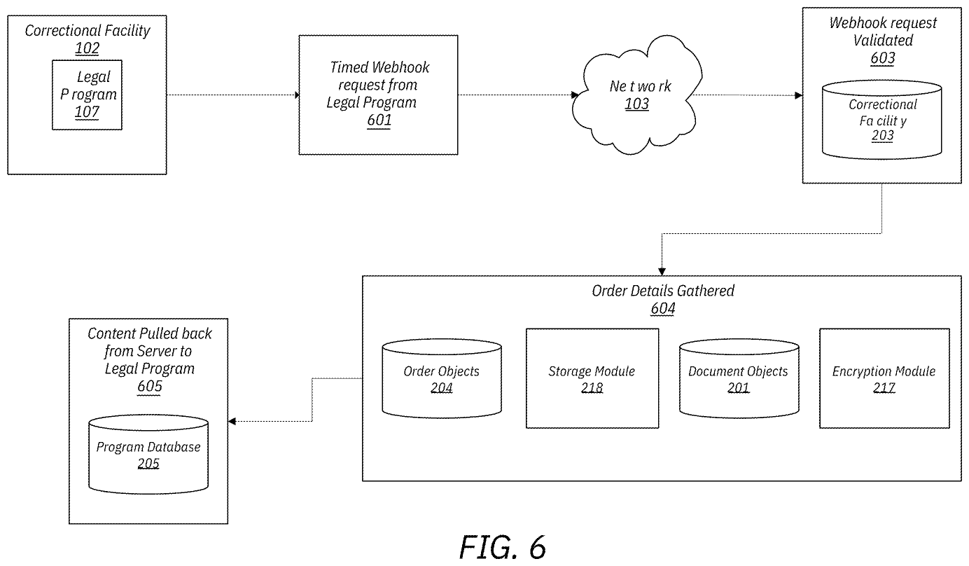

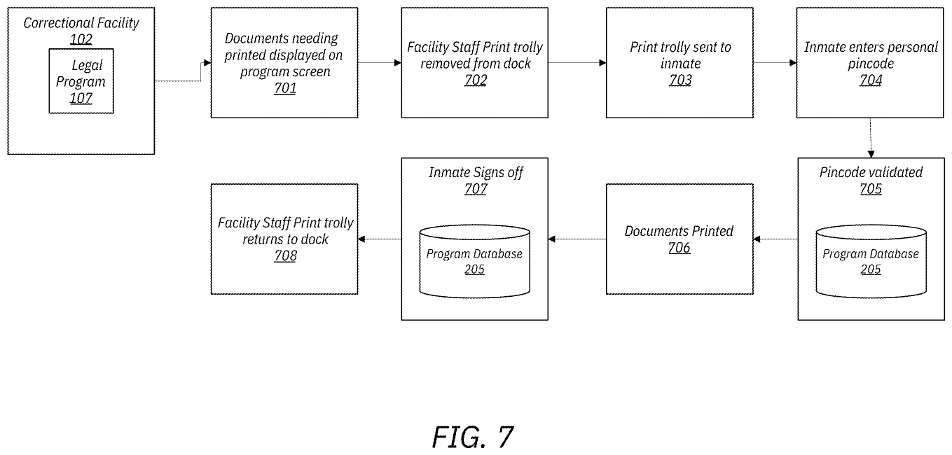

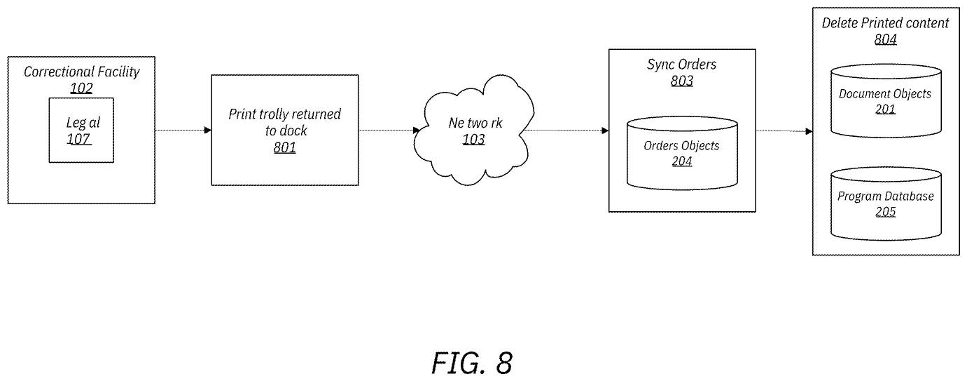

Referring to FIG. 2, FIG. 3, FIG. 4, FIG. 5, FIG. 6, FIG. 7, FIG. 8 in one embodiment the Legal Back Office 105 comprises an upload module 210, synchronization module 212, PDF module 214, logging module 221, order progress module 222. Those of skill in the art will appreciate that the Legal Back Office system 105 may contain other modules that are not described herein. In addition, conventional elements, such as firewalls, authentication systems, payment processing systems, network management tools, load balancers, and so forth are not shown as they are not material to the invention. The system 105 may be implemented using a single computer, or a network of computers, including cloud-based computer implementations. The computers are preferably server class computers including one or more high-performance CPUs and 1 GB or more of main memory, running an operating system such as Linux or variants thereof. The operations of the system 105 as described herein can be controlled through either hardware or through computer programs installed in non-transitory computer storage and executed by the processors to perform the functions described herein. The various modules (e.g., upload module 210, etc.) are implemented using non-transitory computer readable storage devices, and suitable database management systems for data access and retrieval. The system 105 includes other hardware elements necessary for the operations described here, including network interfaces and protocols, input devices for data entry, and output devices for display, printing or other presentations of data.

The document objects store 201 persistently stores uploaded documents in an encrypted form, the details of which are represented in the Back Office System 105. Each uploaded document is represented by document details 509, which may be referred to as document information.

Information about documents includes ID, original file name, original file extension, eTag, encryption, upload date, download date, deletion date, bucket, region, endpoint, object name, object URL, status.

The user objects store 202 persistently stores user details for the system, the details of which are represented in the Back Office System 105. Each user object is represented by user details 306, which may be referred to as user information. Information about users includes ID, first name, last name, created date, last login, email address, password, status, and such like.

The correctional facilities objects store 203 persistently stores details regarding correctional facilities, the details of which are represented in the Back Office System 105. Each correctional facility's object is represented by facility details, which may be referred to as facility information. Information about facilities includes ID, description, and such like.

The order objects store 204 persistently stores data describing order details, and associated documents in the Back Office System 105, and is one means for performing this function. Each order is represented by order details 508, which may also be referred to as order information. Information about orders includes uploaded document references such as document ID, and number of pages, object storage information such as filename, bucket location, URI, inmate details such as first name, ast name, inmate number, unique pin, and the like. Each user of the system is assigned a unique ID, whether a lawyer or member of staff.

The program database 205 persistently stores data describing orders and associated documents from the Back Office System 105, these are synchronized between the Back Office System 105 and the Legal program 107. This per device database stores a slimmed down copy of the document objects store and order objects store.

The upload module 210 comprises multiple functions to leverage the PDF module 214, the encryption module 217, and the storage module 218. The module itself is used to transfer a document from a lawyer 101, to the Back Office System 105, along with relevant details such as the unique inmate pin.

The payment module 211 comprises multiple functions to leverage third party payment providers such as Stripe facilitating payment for placed orders.

The synchronization module 212 comprises multiple functions to allow communication from the Back Office System 105, and the Legal program 107. Providing a secure way via AES 256 bit encryption to pass document objects 201, and order objects 204 to the Legal program 107, whilst also facilitating data flowing in the opposite direction to update order objects 204 as well as document objects 201.

The correctional facility administration module 213 provides administration level staff of the Back Office System 105 to set up, modify and remove correctional facilities from the Back Office System 105.

The PDF module is utilized as a helper module from other functions and allows interaction with uploaded documents, e.g., to query page count before the file is compressed and encrypted.

The authorization module provides a secure function set used to authenticate all users 202 of the Back Office System 105. This module is utilized to gauge user 202 access to the system.

The order administration module 216 is used to provide relevant users 202 with details on placed orders, including details such as date order was placed, the date the order was printed, and the date the file was deleted from storage and such like.

The encryption module 217 is a helper module used throughout the Back Office System 105 to provide encryption capabilities as required, e.g., document objects 201 are encrypted once uploaded, before being transferred to server-side encrypted S3 based object storage.

The storage module 218 is a helper module consisting of functions to interact with S3 based object storage 000, providing functions such as upload of documents objects 209, download of document objects 209, and deletion of document objects 209.

The maintenance module 219 is a helper module comprising functions to assist in the running of the Back Office System 105, such as clearing up temporary files, scheduling other tasks and such like.

The user administration module 220 is used to administer user details 306 on the system, changing their permissions 215, verifying the accounts 215, blocking usage 215, and such like.

The logging module 221 is used extensively throughout the Back Office System 105 for tracking operations such as administrative actions, and order logging.

The order process module 222 is utilized to provide information to lawyers 101 about the orders they have placed on the system.

### Legal Program 107

The legal program 107 itself provides a mechanism for a computer within the correctional facility 102 to synchronize orders and status with the Back Office System 105, providing the following, but not limited to functionality of: synchronizing document objects 201, order objects 204,

to its program database 205 and in the opposite direction back to the Back Office System 105. Decrypting and Printing document objects 201 and recording details for the system log, such as date of print, print ID, order ID and such like. Access control to the legal program 107 based upon entered credentials for facility staff. Recording verification of order receipt from the inmate. Unique PIN unlock for the document objects 201 by the inmates.

Web requests 601 will continuously be sent out from the Legal Program 107 when able to connect to the network 103, these are sent to the Legal Back Office 105 to identify any changes relevant to the specified Correctional Facility 102.

Webhooks 604 exist within the Legal Back Office 105 to catch any web requests 601 from each instant of the Legal Program 107. All webhook requests are secured and handled within the Legal Back office 105 using the synchronization module 212.

Order Details 604 are gathered from the Legal Back Office 105 using the webhooks 604. The main details here are the encrypted documents objects 201 from the lawyer 101 along with the inmate's information and associated decryption pin-code.

All order details 604 from the webhook requests 603 are copied to be stored locally in the Legal Program 107 within the Program database 205.

The Legal Program 107 will display a List of All unprinted documents 701. Staff will use this display as the method to identify and select any printouts which need acted on.

When the Correctional Facility 102 staff are ready to print documents, a cart/trolley holding the Legal Program 107 is removed from its docking position 702. The device is to function at this point without network connection 103 relying on the local Program database 205. The device can then be rolled out to individual inmates at their cells.

To confirm their identity the inmates will need to enter personal pin-code 704 into the Legal Program 107 using a touch screen keyboard. The given pin-code is validated against the details within the local Program database 205.

The inmates documents will only be printed 706 if the preceding pin-code check 704 successfully passes.

The inmate must then sign off 707 to finish the process and be given their printed documents. The sign off process 707 may include photographic evidence or utilizing touch screen on Legal Program 107 host device.

When finished the print jobs, Correctional facility 102 staff will return the Legal Programs 107 host device to dock so that it can reconnect to the network 103.

After re-establishing a network connection 103 the Legal Program will immediately begin polling the Legal Back Office 105 to synchronize orders 803. All information taken about orders from inmates stored in the Program database 205 will be synced back to appropriate parts of the Document Objects 201 and Orders Objects 204. This will allow Lawyer users 101 to view the progress of those orders via the order progress module 222

After completing data synchronization 803 the encrypted documents can be deleted from both the Legal Program system 107 and from the Document Objects 201 in the Legal Back Office 105. This will confirm all files are removed including the s3 storage. Historical order data and logging about the purchases is retained for billing purposes.

### Alternative Applications

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method, comprising: authenticating a verified user, allowing them to place orders comprising of uploaded documents to be received by specified correctional facilities; orders placed on the system are then synchronized with computer hardware at the correctional facility to facilitate in printing of the orders; order data is synchronized back to the system to update order details such as printed status, and date.

1. A system for sending confidential and privileged legal documents to inmates, the system comprising:
a. a server configured to:
i. generate a front end via a web-based application on a client device, the front end comprising a user interface allowing a user of the client device to upload, encrypt and transmit confidential and privileged digital legal documents directly to an inmate at a correctional facility location;
ii. store the confidential digital legal documents to an encrypted database;
iii. generate a location administration interface accessible only by the inmate to access the database, and
iv. transmit the confidential digital legal documents to a printer at the facility location.

2. The system of claim 1 wherein the front end includes a list of facility locations.

3. The system of claim 1 wherein the server is further configured to receive inmate details associated with the confidential digital legal documents, the inmate details including an inmate name, and identification number.

4. The system of claim 1 wherein the front end includes an editor display and space for uploading and encrypting the confidential digital legal documents.

5. The system of claim 4 wherein the editor display includes inmate last name, inmate first initial, inmate number, number of documents uploaded and total page count.

6. The system of claim 1 wherein the facility location comprises a correctional facility, a restrained environment, and/or a restricted-access location.

7. The system of claim 1 wherein the server is further configured to send email notifications to the client device indicating the confidential digital legal document has been printed and delivered directly to the inmate.

8. The system of claim 7 wherein the server is further configured to include a photo and signature of inmate.

9. The system of claim 1 wherein the server is further configured to immediately purge all confidential encrypted legal documents once email notification is sent.

10. The system of claim 1 wherein the server is further configured to assess a fee for printing the confidential digital legal document and delivering the printed confidential digital legal document directly to an inmate recipient.

11. The system of claim 1 wherein the server is further configured to generate a centralized administration interface allowing an administrator to add facility locations, administrate a plurality of facility locations, add users for the centralized administrator interface, add print destinations, set defaults for each of the plurality of facility locations, and configure permission controls for each user of the plurality of facility locations.

12. The system of claim 1 wherein the location administration interface includes a log of all transactions for facility locations and for users.

13. A method, in a data processing system comprising a processor and a memory, for uploading, encrypting and sending confidential legal documents to inmates, the method comprising:
a. generating, by a server, a front end via a web-based application on a client device, the front end comprising a user interface allowing a user of the client device to upload, encrypt and send confidential digital legal documents to an inmate at a facility location;
b. storing, by the server, a confidential encrypted digital legal document to a database;
c. generating, by the server, a location administration interface accessible by one or more users at the facility location to access and print a transaction log of all successful and unsuccessful transactions; and
d. transmitting, by the server, the confidential encrypted digital legal mail to a printer at the facility location.

14. The method of claim 11 further comprising receiving inmate details associated with the confidential digital letter data, the inmate details including an inmate name and identification number.

15. The method of claim 11 wherein the front end includes an editor display and space for uploading confidential digital legal mail.

16. The method of claim 13 wherein the editor display includes number of documents uploaded and actual page count.

17. The method of claim 11 wherein the facility location comprises a correctional facility, a restrained environment, and/or a restricted-access location.

18. The method of claim 11 further comprising sending email notifications to the client device indicating the confidential digital legal mail has been printed and delivered to the inmate.

19. The method of claim 18 whereby the email notification includes an inmate name and signature.

20. The method of claim 11 further comprising assessing a fee for printing the confidential digital legal document and delivering the printed digital legal document directly to an inmate recipient.

21. The method of claim 11 further comprising generating a centralized administration interface allowing an administrator to add facility locations, administrate a plurality of facility locations, add users for the centralized administrator interface, add print destinations, set defaults for each of the plurality of facility locations, and configure permission controls for each user of the plurality of facility locations.

22. The method of claim 11 includes a log of all transactions for facility locations and for users.

23. A method, in a data processing system comprising a processor and a memory, for uploading confidential digital legal mail directly to inmates, the method comprising:
a. receiving, by a server, user information from a client device of a message sender;
b. initiating, by the server, a document upload session by confirming inmate details at a facility location and generating an upload field or editor including space for text input by the message sender;
c. generating, by the server, encryption of the confidential legal documents;
d. saving, by the server, the confidential, encrypted legal document for the upload session to a database;
e. generating, by the server, a preview and pricing based on the legal document data;
f. receiving, by the server, a payment based on the pricing; and
g. transmitting, by the server, the confidential encrypted legal document to the facility location.
